(19) United States
(12) Patent Application Publication
(10) Pub. No.: US 2016/0125560 A1
(43) Pub. Date: May 5, 2016

(54) PREDICTIVE USES OF LARGE SCALE DATA IN SOCIAL NETWORKING APPLICATIONS

(71) Applicant: LinkedIn Corporation, Mountain View, CA (US)

(72) Inventors: Satpreet Harcharan Singh, Chicago, IL (US); Suman Sundaresh, Los Altos, CA (US)

(21) Appl. No.: 14/587,922

(22) Filed: Dec. 31, 2014

Related U.S. Application Data
(60) Provisional application No. 62/073,845, filed on Oct. 31, 2014.

(51) Int. Cl. G06Q 50/20; G06Q 50/00

(52) U.S. Cl. CPC G06Q 50/2053; G06Q 50/01

(57) ABSTRACT

A system and method for generating an admittance prediction based on historical admittance data that predicts whether a particular member of a social networking system will be admitted to a particular education institution is disclosed. A social networking system stores admittance data for a plurality of education institutions. The social networking system receives a request for a prediction concerning whether a first member of a social networking service will be admitted to a first education institution in the plurality of education institutions. The social networking system compares qualification data associated with the first member to admittance data stored in memory of the social networking server. The social networking system generates an admittance prediction based on the comparison of the qualification data associated with the first member with historic admittance data. The social networking system transmits the admittance prediction to the client system for display.

### RELATED APPLICATIONS

This application claims the priority benefit of U.S. Provisional Patent Application Ser. No. 62/073,845, filed Oct. 31, 2014, which is incorporated herein by reference in its entirety.

### TECHNICAL FIELD

The disclosed implementations relate generally to the field of social networks and in particular to a system for generating predictions based on analysis of large scale historic data.

### BACKGROUND

The rise of the computer age has resulted in increased access to personalized services online. As the cost of electronics and networking services drop, many services that were previously provided in person are now provided remotely over the Internet. For example, entertainment has increasingly shifted to the online space with companies such as Netflix and Amazon streaming television shows and movies to members at home. Similarly, electronic mail (e-mail) has reduced the need for letters to be physically delivered. Instead, messages are sent over networked systems almost instantly. Similarly, online social networking sites allow members to build and maintain personal and business relationships in a much more comprehensive and manageable manner.

One important application of new computer technologies is allowing users to explore and learn. Some education tools are being moved such that they can be accessed directly over the Internet. For example, massive open online courses (MOOCs) allow users from different parts of the world to all experience the same education experiences. In addition, even non-network based education can be enhanced by improving access to information about education institutions, programs, and opportunities to interested parties. Networked computer systems can collect and process large amounts of data to streamline and enhance education opportunities.

### DESCRIPTION OF THE DRAWINGS

Some implementations are illustrated by way of example and not limitation in the figures of the accompanying drawings, in which:

FIG. 1 is a network diagram depicting a client-server system that includes various functional components of a social networking system, in accordance with some implementations.

FIG. 2 is a block diagram illustrating a client system, in accordance with some implementations.

FIG. 3 is a block diagram illustrating a social networking system, in accordance with some implementations.

FIG. 4 is a member interface diagram illustrating an example of a member interface, according to some implementations.

FIG. 5 is a flow diagram illustrating a method, in accordance with some implementations, for using a large set of historical admittance data for one or more schools to generate a prediction that determines whether or not a particular member of a social networking system will be admitted to a particular education institution.

FIGS. 6A-6C are block diagrams illustrating architecture of software, which may be installed on any one or more of devices, in accordance with some implementations.

FIG. 7 is a block diagram illustrating architecture of software, which may be installed on any one or more of devices, in accordance with some implementations.

FIG. 8 is a block diagram illustrating components of a machine, according to some example embodiments.

Like reference numerals refer to corresponding parts throughout the drawings.

### DETAILED DESCRIPTION

The present disclosure describes methods, systems and computer program products for generating an admittance prediction based on historical admittance data that predicts whether a particular member of a social networking system will be admitted to a particular education institution in accordance with some implementations. In the following description, for purposes of explanation, numerous specific details are set forth to provide a thorough understanding of the various aspects of different implementations. It will be evident, however, to one skilled in the art that the any particular implementation may be practiced without all of the specific details and/or with variations, permutations, and combinations of the various features and elements described herein.

In some example embodiments, a social networking system stores a large set of historical acceptance data for one or more educational institutions (e.g., universities and colleges). This historical acceptance data represents the admission results of thousands or millions of potential applicants, including lists of members who applied to one or more of the educational institutions, the qualification data associated with each member, and whether the member was admitted to the one or more educational institutions to which they applied.

The social networking system analyzes the historical acceptance data for one or more educational institutions to predict, for a respective member of the social networking system, whether or not that member will be admitted to one or more educational institutions. Once the social networking system generates a prediction for a particular member, the prediction is then transmitted to a client system associated with the member. In some example embodiments, the social networking system only generates a prediction in response to a request from the client system.

In some example embodiments, the social networking system can also suggest alternative education institutions to the member based on the education institution in which the member has already indicated an interest.

In some example embodiments, predictions are generated by organizing qualification data into one or more categories (e.g., work experience, education, test scores, and so on). The social networking system can then generate a score for each category for each prospective student in the historical acceptance data. A category score represents the level to which the member the category score is associated with meets the optimal qualifications for that category. For example, the category score for grade point average (GPA) is a score from 0 (representing the lowest possible GPA) to 1 (representing the highest possible GPA). The social networking system then determines for each category score, based on historical acceptance data, the minimum score needed to be accepted to a particular education institution. For example, if no applicants with a GPA score lower than 0.85 (e.g., representing approximately a 3.5 GPA) were accepted, the minimum acceptable score for the GPA score is 0.85.

In some example embodiments, the social networking system determines whether a respective member meets all the minimum acceptable scores for each category for a particular education institution. In accordance with a determination that the member meets or exceeds the minimum acceptable scores for each category, the social networking system generates a predication that the member will be accepted in to the particular education institution. The predication is then transmitted to the client system associated with the member.

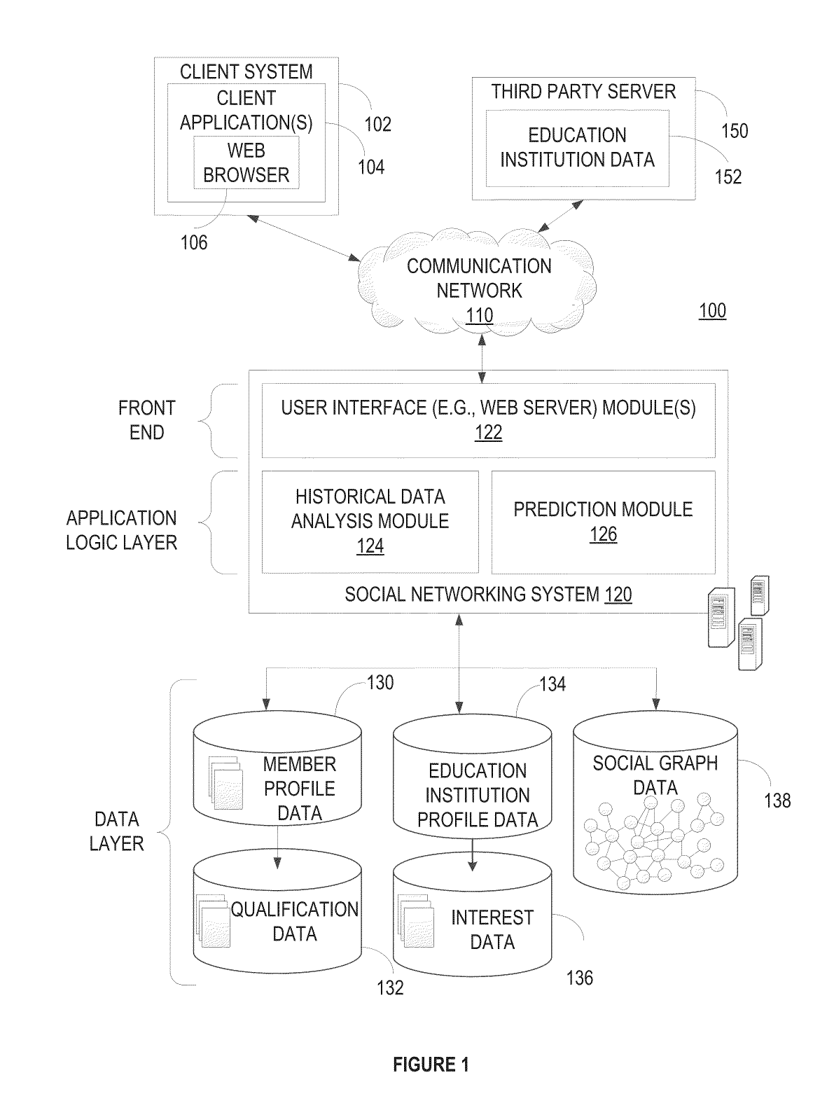

FIG. 1 is a network diagram depicting a client-social networking system environment 100 that includes various functional components of a social networking system 120, in accordance with some implementations. The client-social networking system environment 100 includes one or more client systems 102, a social networking system 120, and one or more other third party servers 150. One or more communication networks 110 interconnect these components. The communication networks 110 may be any of a variety of network types, including local area networks (LANs), wide area networks (WANs), wireless networks, wired networks, the Internet, personal area networks (PANs), or a combination of such networks.

In some implementations, a client system 102 is an electronic device, such as a personal computer (PC), a laptop, a smartphone, a tablet, a mobile phone, or any other electronic device capable of communication with a communication network 110. The client system 102 includes one or more client applications 104, which are executed by the client system 102. In some implementations, the client application(s) 104 include one or more applications from a set consisting of search applications, communication applications, productivity applications, game applications, word processing applications, or any other useful applications. The client application(s) 104 include a web browser 106. The client system 102 uses the web browser 106 to communicate with the social networking system 120 and displays information received from the social networking system 120. In some implementations, the client system 102 includes an application specifically customized for communication with the social networking system 120 (e.g., a LinkedIn iPhone application). In some example embodiments, the social networking system 120 is a server system that is associated with a social networking service. However, the social networking system 120 and the server system that actually provides the social networking service may be completely distinct computer systems.

In some implementations, the client system 102 sends a request to the social networking system 120 for a webpage associated with the social networking system 120 (e.g., the client system 102 sends a request to the social networking system 120 for an updated web page associated with an education institution). For example, a member of the client system 102 logs onto the social networking system 120 and clicks to view educational information on a dedicated web page of the social networking system 120. In response, the client system 102 receives the requested data (e.g., information about schools and enrollment) and displays them on the client system 102.

In some implementations, as shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various implementations have been omitted from FIG. 1. However, a skilled artisan will readily recognize that various additional functional modules and engines may be used with a social networking system 120, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although depicted in FIG. 1 as a three-tiered architecture, the various implementations are by no means limited to this architecture.

As shown in FIG. 1, the front end consists of a user interface module (e.g., a web server) 122, which receives requests from various client systems 102, and communicates appropriate responses to the requesting client systems 102. For example, the user interface module(s) 122 may receive requests in the form of Hypertext Transport Protocol (HTTP) requests, or other web-based, application programming interface (API) requests. The client system 102 may be executing conventional web browser applications or applications that have been developed for a specific platform to include any of a wide variety of mobile devices and operating systems.

As shown in FIG. 1, the data layer includes several databases, including databases for storing data for various members of the social networking system 120, including member profile data 130, qualification data 132 (e.g., data describing the qualifications of one or more members of the social networking system), education institution profile data 134, historic acceptance data 136 (e.g., data that describes a list of applicants to a school, their qualification data, and whether each applicant in the list of applicants was accepted to attend the education institution or not), and a social graph database 138, which is a particular type of database that uses graph structures with nodes, edges, and properties to represent and store data. Of course, with various alternative implementations, any number of other entities might be included in the social graph (e.g., companies, organizations, schools and universities, religious groups, non-profit organizations, governmental organizations, non-government organizations (NGOs), and any other group), and as such, various other databases may be used to store data corresponding with other entities.

Consistent with some implementations, when a person initially registers to become a member of the social networking system 120, the person will be prompted to provide some personal information, such as his or her name, age (e.g., birth date), gender, interests, contact information, home town, address, educational background (e.g., schools, majors, etc.), current job title, job description, industry, employment history, skills, professional organizations, memberships with third party servers 150, and so on. This information is stored, for example, in the member profile database 130. In some example embodiments, the social networking system 120 will also prompt the person to determine whether that person is interested in attending one or more schools in the future.

In some implementations, the member profile data 130 includes qualification data 132. In other implementations, the qualification data 132 is distinct from, but associated with, the member profile data 130. The qualification data 132 stores data for at least some of the members of the social networking system 120. Qualification data includes, but is not limited to, test scores, employment history, demographic information, work history, education history, grade point averages, hobbies, accomplishments, member ratings, recommendations, and so on.

The education institution profile data 134 also stores data related to schools represented on the social networking system 120 and their students. Thus, members of the social networking system 120 may be associated with schools. In addition, education institution profile data 134 includes information that describes the location of the school, the programs it offers, the demographic information of its students, the costs of school, scholarship programs offered by the school, important school dates (e.g., deadlines, term beginning and ending dates, holidays, and so on), ranking information on the school, enrollment statistics, and other information.

In some example embodiments, the historical acceptance data 136 stores data that describes, for a respective education institution in a plurality of education institutions, a list of applicants to the respective education institution, their qualification data, and, for each respective applicant in the list of applicants, whether the respective education institution accepted the respective applicant or not. In some example embodiments, the historical acceptance data 136 is data provided by the education institutions directly. In other example embodiments, the historical acceptance data 136 is derived from information stored in the member profile data 130 including a list of education institutions in which a particular member is interested (or has applied to), the qualifications the particular member has, and whether the respective member later updated their education history to include one or more education institutions. For example, a member with an interest in school A for school year B who later updates their member profile to include attending school A will be determined as having been accepted to school A. Conversely, if no education institution or school is then listed in the member's profile, then the member is determined not to be accepted to school A.

In other example embodiments, the historical acceptance data 136 is received from one or more education institutions. The education institutions transmit a list of applicants to the social networking system (e.g., social networking system 120 of FIG. 1) and include all qualification data for each member. In some example embodiments, personal identifying information is removed from the historical acceptance data 136 in response to privacy concerns. In yet other embodiments, the historical acceptance data 136 is based on data received directly from the members themselves (e.g., the member reports which education institutions the member applied to and which education institutions the member was admitted). This data can be collected from a large number of members and then anonymized to produce a large set of historical acceptance data from a plurality of education institutions.

Once registered, a member may invite other members, or be invited by other members, to connect via the network service. A “connection” may include a bi-lateral agreement by the members, such that both members acknowledge the establishment of the connection. Similarly, with some implementations, a member may elect to “follow” another member. In contrast to establishing a “connection,” the concept of “following” another member typically is a unilateral operation and, at least with some implementations, does not include acknowledgement or approval by the member that is being followed. When one member follows another, the member who is following may receive automatic notifications about various activities undertaken by the member being followed. In addition to following another member, a member may elect to follow a company, a topic, a conversation, or some other entity, which may or may not be included in the social graph. Various other types of relationships may exist between different entities and are represented in the social graph database 138.

The social networking system 120 may provide a broad range of other applications and services that allow members the opportunity to share and receive information, often customized to the interests of the member. In some implementations, the social networking service may include a photo sharing application that allows members to upload and share photos with other members. As such, at least with some implementations, a photograph may be a property or entity included within a social graph. With some implementations, members of a social networking service may be able to self-organize into groups, or interest groups, organized around a subject matter or topic of interest. In some implementations, the data for a group may be stored in a database. When a member joins a group, his or her membership in the group will be reflected in the organization activity data, the member activity data, and the social graph data stored in the social graph database 138.

In some implementations, the application logic layer includes various application server modules, which, in conjunction with the user interface module(s) 122, generates various user interfaces (e.g., web pages) with data retrieved from various data sources in the data layer. With some implementations, individual application server modules are used to implement the functionality associated with various applications, services, and features of the social networking service. For instance, a messaging application, such as an email application, an instant messaging application, or some hybrid or variation of the two, may be implemented with one or more application server modules. Similarly, a search engine enabling members to search for and browse member profiles may be implemented with one or more application server modules. Of course, other applications or services that utilize a historical data analysis module 124 or a prediction module 126 may be separately implemented in their own application server modules.

In addition to the various application server modules, the application logic layer includes a historical data analysis module 124 and a prediction module 126. As illustrated in FIG. 1, with some implementations, the historical data analysis module 124 and the prediction module 126 are implemented as services that operate in conjunction with various application server modules. For instance, any number of individual application server modules can invoke the functionality of the historical data analysis module 124 or the prediction module 126. However, with various alternative implementations, the historical data analysis module 124 and the prediction module 126 may be implemented as their own application server module such that it operates as a stand-alone application. With some implementations, the historical data analysis module 124 and the prediction module 126 include or have an associated publicly available API that enables third-party applications to invoke the functionality they provide.

Generally, the historical data analysis module 124 gathers and analyzes historical acceptance data for a plurality of education institutions. Each respective education institution has an associated list of applicants (e.g., members who applied to attend the respective education institution), the qualification data 132 associated with each applicant, and a determination concerning whether the member were accepted into the respective education institution. In some example embodiments, any historical acceptance data stored without any personal identifying information (PII). Thus all the historical acceptance data is stored anonymously. In other example embodiments, the historical data analysis module 124 infers whether each applicant was accepted based on updates to the applicant's member profile.

In some example embodiments, the historical data analysis module 124 creates a profile of a minimum accepted applicant for each respective education institution by creating one or more categories from the qualification data 132. A profile of a minimum accepted applicant includes an estimated minimum level of qualification data needed to be accepted to the respective education institution.

The historical data analysis module 124 generates a category score for each category for each respective applicant in the list of applicants. The category score represents the degree to which the qualification data in that category makes the applicant a good candidate. For example, in work history, the type of employment (based on employer and title) and the number of year of experience determine how high the category score is.

In some example embodiments, the historical data analysis module 124 then determines, for each category, a minimum acceptable score (e.g., the lowest score for that category that had an applicant be admitted) for a respective school. Once minimum acceptable scores have been determined for each category, the historical data analysis module 124 sends the list of minimum acceptable scores to the prediction module 126. In some example embodiments, the historical data analysis module 124 also determines an average acceptable score (the average (or median) score for all accepted applicants) and transmits it to the prediction module 126.

In some example embodiments, the prediction module 126 uses the list of minimum acceptable scores to predict whether a particular member will be accepted into a respective education institution. The prediction module 126 determines whether any of the category scores are below the minimum acceptable score. If any of the category scores are below the minimum acceptable score for that category, the prediction module 126 determines that the particular member is unlikely to be admitted.

In some example embodiments, in accordance with a determination that none of the particular member's category scores are below the minimum acceptable score, the prediction module 126 compares the particular member's category scores to average acceptance scores for the categories. For example, if the average acceptance score for LSAT scores at a law school is 170, the prediction module 126 determines whether a particular member's LSAT is above 170.

In some example embodiments, the prediction module 126 determines the percentage of category scores for the particular member that are above the respective average acceptance score. For example, the prediction module 126 determines that four of the category scores (out of a total of ten category scores) associated with Member A are above the average category scores for their respective category. Thus the percentage of category scores above average is forty percent. The prediction module 126 then generates an acceptance prediction for the respective member based on one or more of the category scores, the percentage of category scores above average, the number of category scores below the minimum acceptable score, and so on.

In some example embodiments, the higher the percentage of category scores above the average score the more likely that the prediction module 126 will return a prediction that the respective member will be accepted. In some example embodiments, different category scores have different weights, such that a high category score for a particular category is more important than other category scores. The prediction module 126 then transmits the prediction to the client system 102 associated with the particular member.

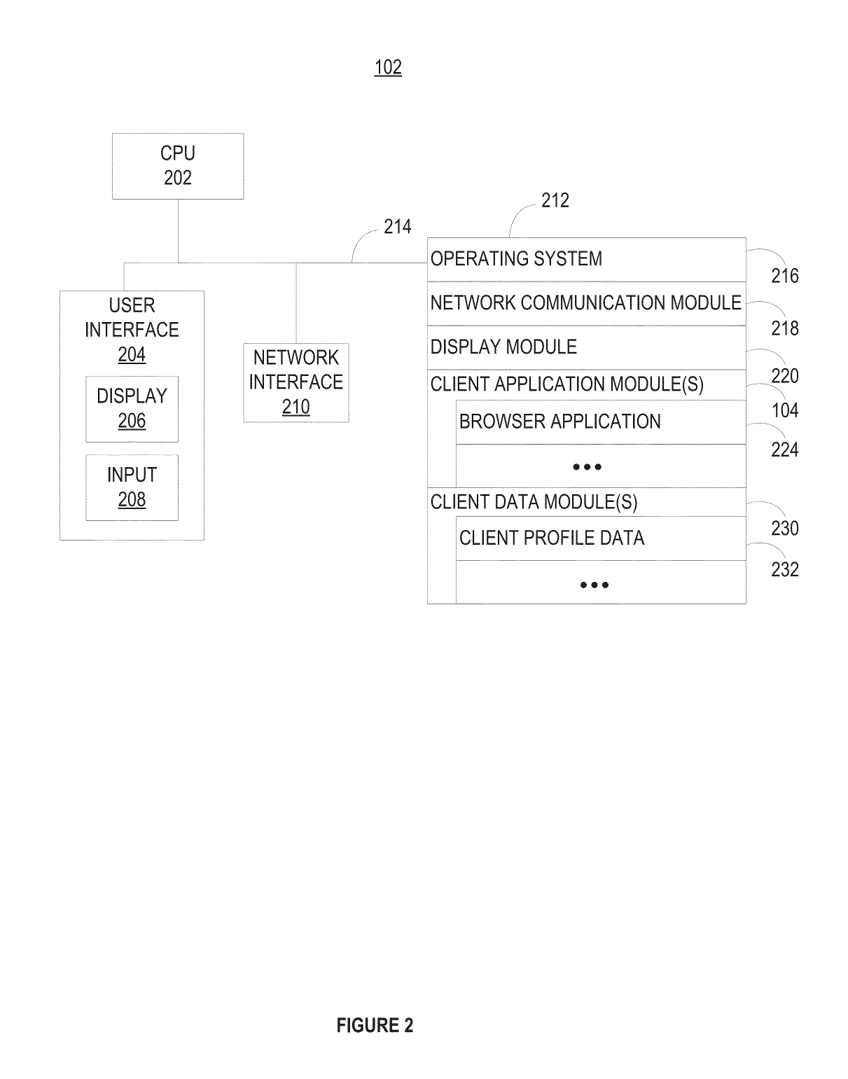

FIG. 2 is a block diagram illustrating a client system 102, in accordance with some implementations. The client system 102 typically includes one or more central processing units (CPUs) 202, one or more network interfaces 210, memory 212, and one or more communication buses 214 for interconnecting these components. The client system 102 includes a user interface 204. The user interface 204 includes a display device 206 and optionally includes an input means such as a keyboard, mouse, a touch sensitive display, or other input buttons 208. Furthermore, some client systems 102 use a microphone and voice recognition to supplement or replace the keyboard.

Memory 212 includes high-speed random access memory, such as dynamic random-access memory (DRAM), static random access memory (SRAM), double data rate random access memory (DDR RAM) or other random access solid state memory devices; and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternately, the non-volatile memory device(s) within memory 212, comprise(s) a non-transitory computer readable storage medium.

In some implementations, memory 212 or the computer readable storage medium of memory 212 stores the following programs, modules, and data structures, or a subset thereof:
an operating system 216 that includes procedures for handling various basic system services and for performing hardware dependent tasks;
a network communication module 218 that is used for connecting the client system 102 to other computers via the one or more communication network interfaces 210 (wired or wireless) and one or more communication networks, such as the Internet, other WANs, LANs, metropolitan area networks (MANs), etc.;
a display module 220 for enabling the information generated by the operating system 216 and client applications 104 to be presented visually on the display device 206;
one or more client applications 104 for handling various aspects of interacting with the social network social networking system (FIG. 1, 120), including but not limited to:
   a browser application 224 for requesting information from the social networking system 120 (e.g., product pages and member information) and receiving responses from the social networking system 120; and
a client data module 230, for storing data relevant to the clients, including but not limited to:
   client profile data 232 for storing profile data related to a member of the social network social networking system 120 associated with the client system 102.

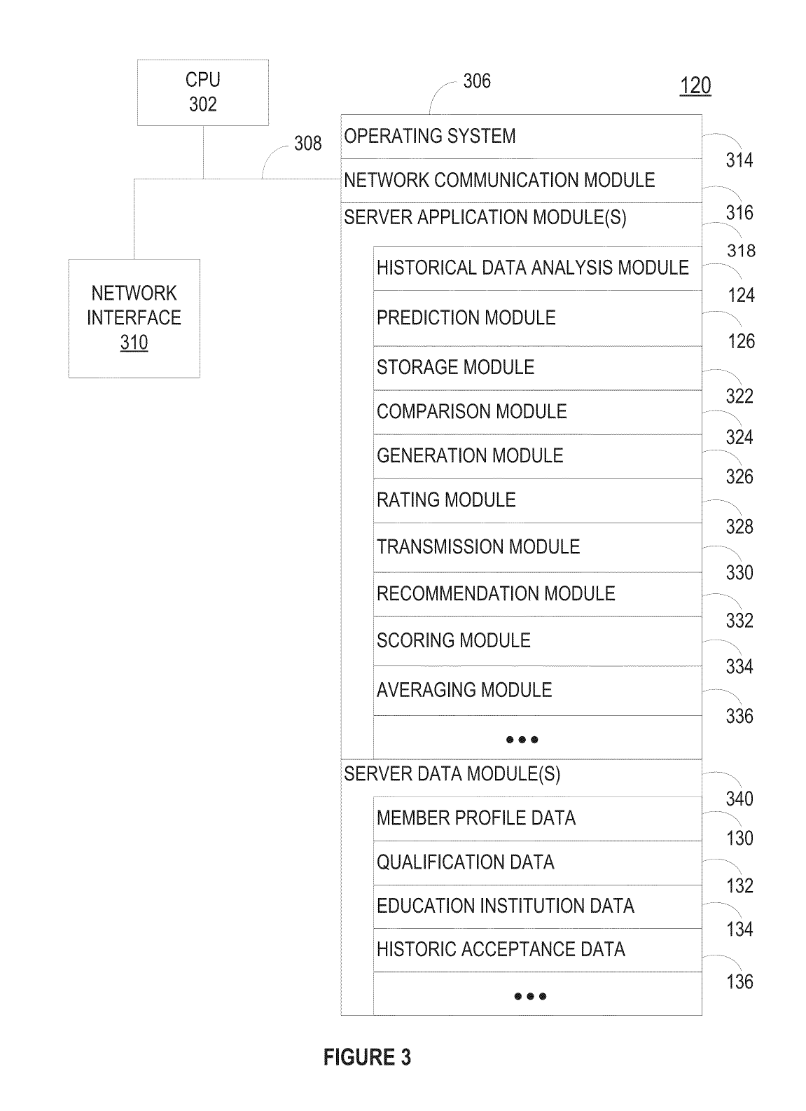

FIG. 3 is a block diagram illustrating a social networking system 120, in accordance with some implementations. The social networking system 120 typically includes one or more CPUs 302, one or more network interfaces 310, memory 306, and one or more communication buses 308 for interconnecting these components. Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302.

Memory 306, or alternately the non-volatile memory device(s) within memory 306, comprises a non-transitory computer readable storage medium. In some implementations, memory 306 or the computer readable storage medium of memory 306 stores the following programs, modules, and data structures, or a subset thereof:
an operating system 314 that includes procedures for handling various basic system services and for performing hardware dependent tasks;
a network communication module 316 that is used for connecting the social networking system 120 to other computers via the one or more communication network interfaces 310 (wired or wireless) and one or more communication networks, such as the Internet, other WANs, LANs, MANs, and so on;
one or more server application modules 318 for performing the services offered by social networking system 120, including but not limited to:
   a historical data analysis module 124 for analyzing historic acceptance data for one or more education institutions;
   a prediction module 126 for generating a prediction about whether or not a first member of a social networking system (e.g., social networking system 120 of FIG. 1) would be accepted into one or more education institutions;
   a storage module 322 for receiving and storing historic acceptance data for one or more education institutions
   a comparison module 324 for comparing a first member's profile (or qualification data 132) to historic acceptance data 136 for at least one education institution;
   a generation module 326 for generating an acceptance prediction for a first member;
   a rating module 328 for generating a rating for a particular education institution such that the rating module can identified one or more comparable education institution;
   a transmission module 330 for transmitting data, including an acceptance prediction, to a client system (e.g., system 102 in FIG. 1);
   a recommendation module 332 for determining one or more education institutions into which a first member has a high likelihood of being accepted and sending a recommendation to the client system (e.g., system 102 in FIG. 1) associated with the first member;
   a scoring module 334 for determining a category score for a particular category and a particular member based on qualification data associated with the particular member; and
   an averaging module 336 for determining average acceptance category scores for one or more categories based on stored historic acceptance data 136; and
server data modules 340, holding data related to social network social networking system 120, including but not limited to:
   member profile data 130 including both data provided by the member who will be prompted to provide some personal information, such as his or her name, age (e.g., birth date), gender, interests, contact information, home town, address, educational background (e.g., schools, majors, etc.), current job title, job description, industry, employment history, skills, professional organizations, memberships to other social networks, customers, past business relationships, and seller preferences; and inferred member information based on member activity, social graph data, overall trend data for the social networking system 120, and so on;
   qualification data 132 including data that represents the various categories of data an education institution might use to determine whether or not to accept an applicant;
   education institution profile data 134 including data describing one or more education institutions (e.g., location, educational programs offer, applicants, alumni, reputation score, etc.); and
   historic acceptance data 136 including data that lists, for one or more education institutions, a plurality of applicants to the one or more education institutions, qualification data 132 for those applicants, and a record of whether each of the respective applicants was accepted or not.

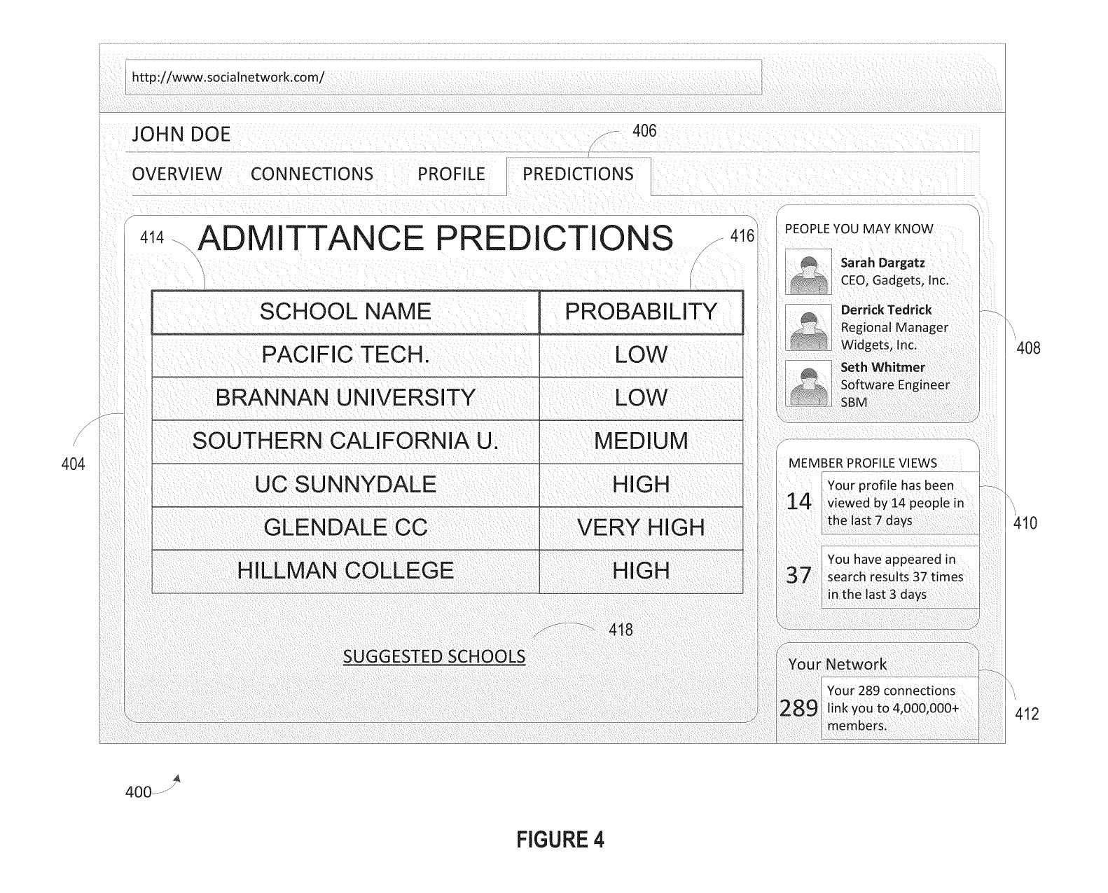

FIG. 4 is a member interface diagram illustrating an example of a user interface 400 or web page that incorporates data describing one or more predictions regarding the member's likelihood of being accepted into one or more education institutions in a social networking service. The user interface 400 has prediction information for a particular member of the social networking system (e.g., social networking system 120 of FIG. 1) displayed in a web page 404. As can be seen, the predictions tab 406 has been selected. The predictions web page 404 includes a list of schools 414 in which Member A is interested. Each education institution has an accompanying prediction 416 that represents the likelihood that Member A will be accepted into each education institution if Member A were to apply.

In addition, the user interface 400 also includes a list of suggested education institutions 418. These are education institutions that the social networking system (e.g., social networking system 120 of FIG. 1) has determined might be interesting to Member A based on the profile data of Member A and the education institutions in which Member A has already indicated an interest. In some example embodiments, each suggested education institution also has an associated prediction that represents the likelihood of the member being accepted.

The user interface 400 also includes information in side sections of the interface including a contact recommendation section 408, profile viewership statistic section 410, and a social graph statistic section 412.

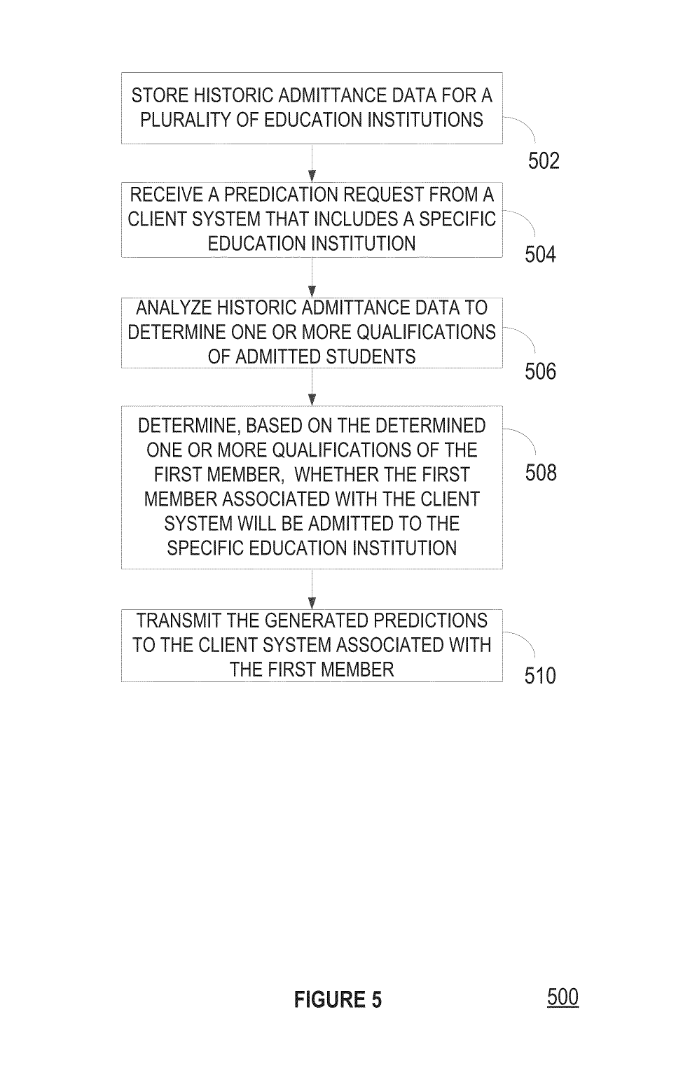

FIG. 5 is a flow diagram illustrating a method, in accordance with some example embodiments, for generating an admittance prediction based on historical admittance data that predicts whether a particular member of a social networking system will be admitted to a particular education institution in accordance with some implementations. Each of the operations shown in FIG. 5 may correspond to instructions stored in a computer memory or computer readable storage medium. Optional operations are indicated by dashed lines (e.g., boxes with dashed-line borders). In some implementations, the method described in FIG. 5 is performed by the social networking system (e.g., system 120 in FIG. 1).

In some implementations, the method is performed at a social networking system (e.g., system 120 in FIG. 1) including one or more processors and memory storing one or more programs for execution by the one or more processors.

The social networking system (e.g., system 120 in FIG. 1) stores (502) historic admittance data for a plurality of education institution. The stored historic admittance data includes a list of applicants to the education institution, the qualification data for the applicants, and whether the applicant was admitted. In some example embodiments, this historic admittance data is received from one or more education institutions. In other example embodiments, the historic admittance data is gathered based on changes in member profiles.

In some example embodiments, the social networking system (e.g., social networking system 120 of FIG. 1) receives a predication request (504) from a client system that includes a specific education institution. For example, a member B is interested in University A and sends a request to the social networking system (e.g., social networking system 120 of FIG. 1) to determine the likelihood that member B will be admitted into University A.

The social networking system (e.g., social networking system 120 of FIG. 1) analyzes historic admittance data to determine (506) one or more common qualifications of admitted students. In some example embodiments, the social networking system (e.g., social networking system 120 of FIG. 1) determines (508), based on the determined one or more qualifications of the first member, whether the first member associated with the client system will be admitted to the specific education institution.

In some example embodiments, the social networking system (e.g., social networking system 120 of FIG. 1) transmits (510) the generated predictions to the client system (e.g., system 102 in FIG. 1) associated with the first member.

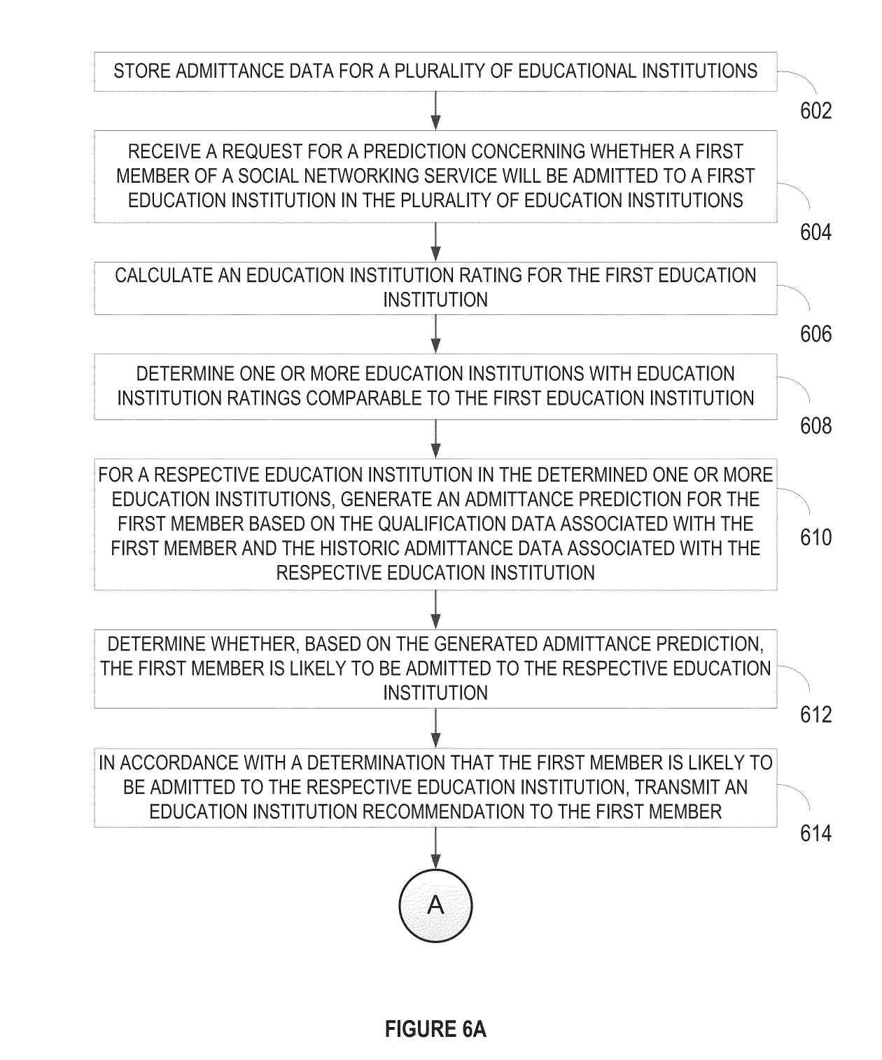

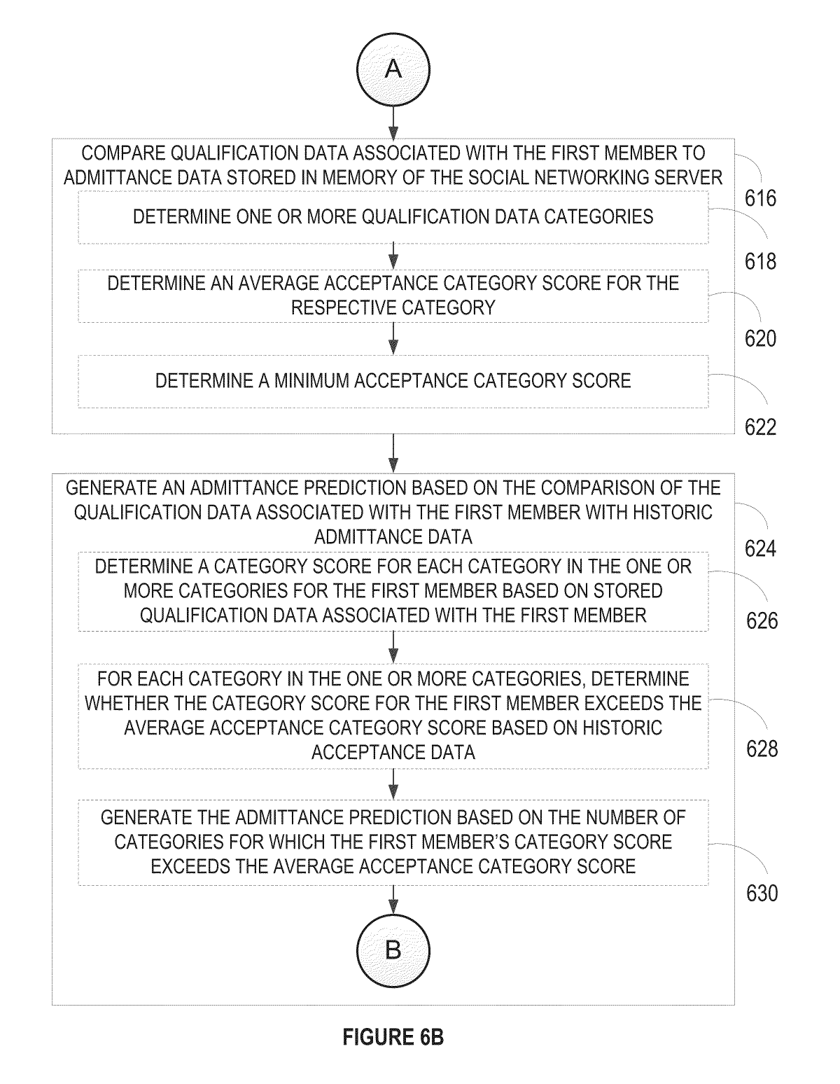

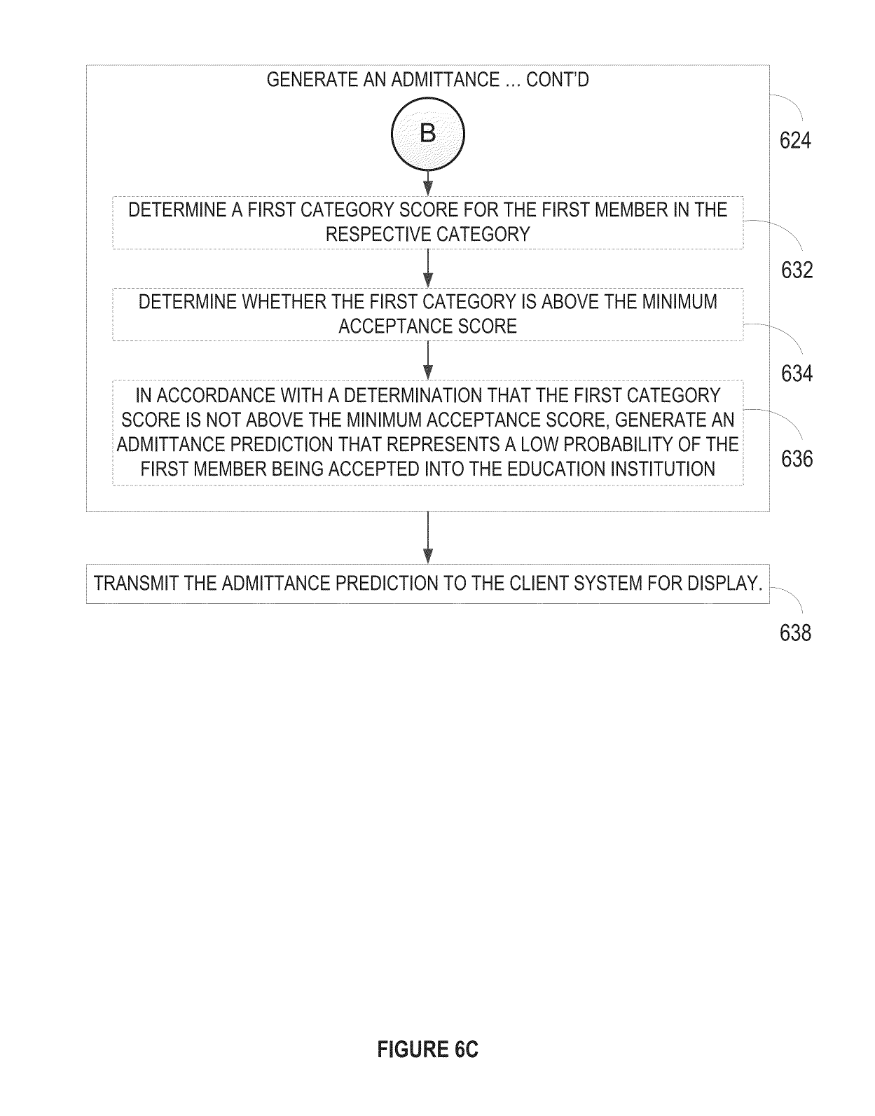

FIG. 6A is a flow diagram illustrating a method for generating an admittance prediction based on historical admittance data that predicts whether a particular member of a social networking system will be admitted to a particular education institution in accordance with some implementations. Each of the operations shown in FIG. 6A may correspond to instructions stored in a computer memory or computer-readable storage medium. Optional operations are indicated by dashed lines (e.g., boxes with dashed-line borders). In some implementations, the method described in FIG. 6A is performed by the social networking system (e.g., social networking system 120 of FIG. 1). However, the method described can also be performed by any other suitable configuration of electronic hardware.

In some implementations the method is performed at a social networking system (e.g., social networking system 120 of FIG. 1) including one or more processors and memory storing one or more programs for execution by the one or more processors.

In some example embodiments, the social networking system (e.g., social networking system 120 of FIG. 1) stores (602) admittance data for a plurality of education institutions. The stored historic admittance data includes a list of applicants to the education institution, the qualification data for the applicants, and whether the applicant was admitted. In some example embodiments, stored historical admittance data has been filtered to remove any personal identification information such that no particular applicant is identifiable.

In some example embodiments, historic admittance data for a respective education institution is received from the respective education institution directly. For example, a university contracts with the social networking system (e.g., social networking system 120 of FIG. 1) to improve information for applicants and transmits historical application data to the social networking system (e.g., social networking system 120 of FIG. 1).

In some example embodiments, the historic admittance data includes one or more potential students who were accepted by the respective education institution but did not attend the educational institution.

In some example embodiments, historic admittance data for a respective school includes data that identifies a plurality of potential students who applied and were accepted and a plurality of students who applied to the respective school and were rejected. In other example embodiments, historic admittance data includes, for each respective potential student, qualification data associated with the respective potential student.

In some example embodiments, the social networking system (e.g., social networking system 120 of FIG. 1) receives (604) a request for a prediction concerning whether a first member of a social networking service will be admitted to a first education institution in the plurality of education institutions. In some example embodiments, the request for a prediction is received from a computer system (e.g., client system 102 in FIG. 1) associated with the first member (e.g., a computer system the first member is currently using). In some example embodiments, the request is sent in response to member selection of a specific link or button that triggers the request. In other example embodiments, the request is triggered in response to an indirect signal, such as automatically triggering the request in response to the member visiting a website associated with the first education institution.

In some example embodiments, the social networking system (e.g., social networking system 120 of FIG. 1) calculates (606) an education institution rating for the first education institution. An education institution rating is a rating or score that gives a relative prestige score for a particular education institution. In some example embodiments, the education institution rating is created by a third party (e.g., a school rating body). In some example embodiments, each education institution has one or more different education institution ratings for each department or academic area of focus. In some example embodiments, the education institution ratings are developed based on an analysis of the qualifications of attending students, career outcomes, peer reviews, and any other data.

In some example embodiments, the social networking system (e.g., social networking system 120 of FIG. 1) determines (608) one or more education institutions with education institution ratings comparable to the first education institution. For example, the social networking system (e.g., social networking system 120 of FIG. 1) identifies one or more education institutions that have similar prestige ratings or similar career outcome scores to the first education institution. In some example embodiments, the social networking system (e.g., social networking system 120 of FIG. 1) also considers the geographic location of the first education institution and the member (e.g., if the member appears to favor education institutions in a specific geographic locations).

In some example embodiments, for a respective education institution in the determined one or more education institutions, the social networking system (e.g., social networking system 120 of FIG. 1) generates (610) an admittance prediction for the first member based on the qualification data associated with the first member and the historic admittance data associated with the respective education institution.

In some example embodiments, the social networking system (e.g., social networking system 120 of FIG. 1) determines (612) whether, based on the generated admittance prediction, the first member is likely to be admitted to the respective education institution. For example, the social networking system (e.g., social networking system 120 of FIG. 1) uses a model to analyze a potential applicant and determine how well the potential applicant and the education institution match. If the match is determined to be good, the chance of admittance is high; if not, the chance to be admitted is determined to be low.

In some example embodiments, in accordance with a determination that the first member is likely to be admitted to the respective education institution, the social networking system (e.g., social networking system 120 of FIG. 1) transmits (614) an education institution recommendation to the first member (e.g., transmits information that causes the recommendation to be displayed to the first member on a web page requested by the first member).

FIG. 6B is a flow diagram illustrating a method for generating an admittance prediction based on historical admittance data that predicts whether a particular member of a social networking system will be admitted to a particular education institution in accordance with some implementations. Each of the operations shown in FIG. 6B may correspond to instructions stored in a computer memory or computer-readable storage medium. Optional operations are indicated by dashed lines (e.g., boxes with dashed-line borders). In some implementations, the method described in FIG. 6B is performed by the social networking system (e.g., social networking system 120 of FIG. 1). However, the method described can also be performed by any other suitable configuration of electronic hardware.

In some implementations the method is performed at a social networking system (e.g., social networking system 120 of FIG. 1) including one or more processors and memory storing one or more programs for execution by the one or more processors.

In some example embodiments, the social networking system (e.g., social networking system 120 of FIG. 1) compares (616) qualification data associated with the first member to historical admittance data stored in a memory of the social networking server. In some example embodiments, comparing qualification data for the first member to historic admittance data includes the social networking system (e.g., social networking system 120 of FIG. 1) determining (618) one or more qualification data categories. Qualification data categories can be predetermined (e.g., selected before information is processed) or automatically generated based on models that are built in the process of analyzing information. In some example embodiments, the models enable the social networking system (e.g., social networking system 120 of FIG. 1) to automatically create or change categories to create better matching outcomes for members (e.g., potential students) and education institutions.

In some example embodiments, for a respective category in the one or more qualification data categories, the social networking system (e.g., social networking system 120 of FIG. 1) determines (620) an average acceptance category score for the respective category. In some example embodiments, the average acceptance score is the average category score for a particular category for all the accepted applicants. In some example embodiments, the average acceptance score is the median category score for a particular category for all the accepted applicants.

In some example embodiments, the social networking system (e.g., social networking system 120 of FIG. 1) determines (622) a minimum acceptance category score. A minimum acceptance category score is the lowest category score for the respective category that still resulted in admission (e.g., the worst score in a category that still resulted in admission).

In some example embodiments, admittance prediction is represented as a percentage representing the likelihood that the member will be accepted into the respective education institution. For example, the chance of admission is 75%, which represents the likelihood that the member will be accepted into the education institution if the member applies. In some example embodiments, the admittance prediction is represented by one of a plurality of discrete states. For example, all potential applicants are given a “high,” “medium,” or “low” chance of admittance to a respective education institution based on the analysis of the social networking system (e.g., social networking system 120 of FIG. 1). In some example embodiments, the admittance prediction is generated through one or more techniques, including but not limited to machine learning approaches such as logistic regression, neural networks, and so on).

In some example embodiments, the social networking system (e.g., social networking system 120 of FIG. 1) generates (624) an admittance prediction based on the comparison of the qualification data associated with the first member with historic admittance data.

In some example embodiments, generating an admittance prediction based on the comparison with historic admittance data further comprises the social networking system (e.g., social networking system 120 of FIG. 1) determining (626) a category score for each category in the one or more categories for the first member based on stored qualification data associated with the first member. For example, the social networking system (e.g., social networking system 120 of FIG. 1) generates a score by normalizing the data for a category to generate a number between 0 and 1.0, wherein 0 is the lowest qualifications and 1 is the best possible qualifications.

In some example embodiments, for each category in the one or more categories, the social networking system (e.g., social networking system 120 of FIG. 1) determines (628) whether the category score for the first member exceeds the average acceptance category score based on historic acceptance data. The social networking system (e.g., social networking system 120 of FIG. 1) generates (630) an admittance prediction based on the number of categories for which the first member's category score exceeds the average acceptance category score. For example, based on a model, the social networking system (e.g., social networking system 120 of FIG. 1) determines that an applicant who exceeds category averages in most of the categories has a high chance of admittance. Similarly, if an applicant has few category scores that exceed their respective category averages, the social networking system (e.g., social networking system 120 of FIG. 1) determines that the applicant has a low chance of admittance.

FIG. 6C is a flow diagram illustrating a method for generating an admittance prediction based on historical admittance data that predicts whether a particular member of a social networking system will be admitted to a particular education institution in accordance with some implementations. Each of the operations shown in FIG. 6C may correspond to instructions stored in a computer memory or computer-readable storage medium. Optional operations are indicated by dashed lines (e.g., boxes with dashed-line borders). In some implementations, the method described in FIG. 6C is performed by the social networking system (e.g., social networking system 120 of FIG. 1). However, the method described can also be performed by any other suitable configuration of electronic hardware.

In some implementations, the method is performed at a social networking system (e.g., social networking system 120 of FIG. 1) including one or more processors and memory storing one or more programs for execution by the one or more processors.

In some example embodiments, when generating an admittance prediction based on the comparison with historic admittance data comprises, the social networking system (e.g., social networking system 120 of FIG. 1) determines (632) a first category score for the first member in the respective category. In some example embodiments, the social networking system (e.g., social networking system 120 of FIG. 1) determines (634) whether the first category is above the minimum acceptance score. In accordance with a determination that the first category score is not above the minimum acceptance score, the social networking system (e.g., social networking system 120 of FIG. 1) generates (636) an admittance prediction that represents a low probability of the first member being accepted into the education institution.

In some example embodiments, the social networking system (e.g., social networking system 120 of FIG. 1) transmits (638) the admittance prediction to the client system for display.

### Software Architecture

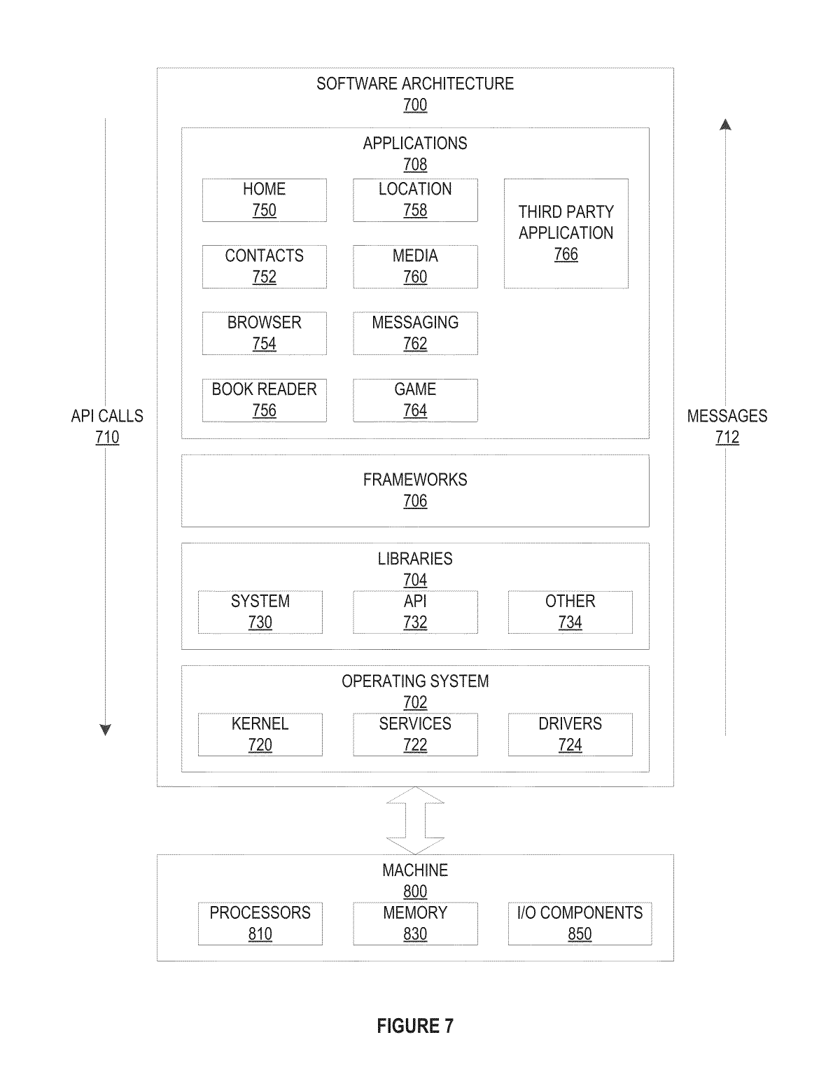

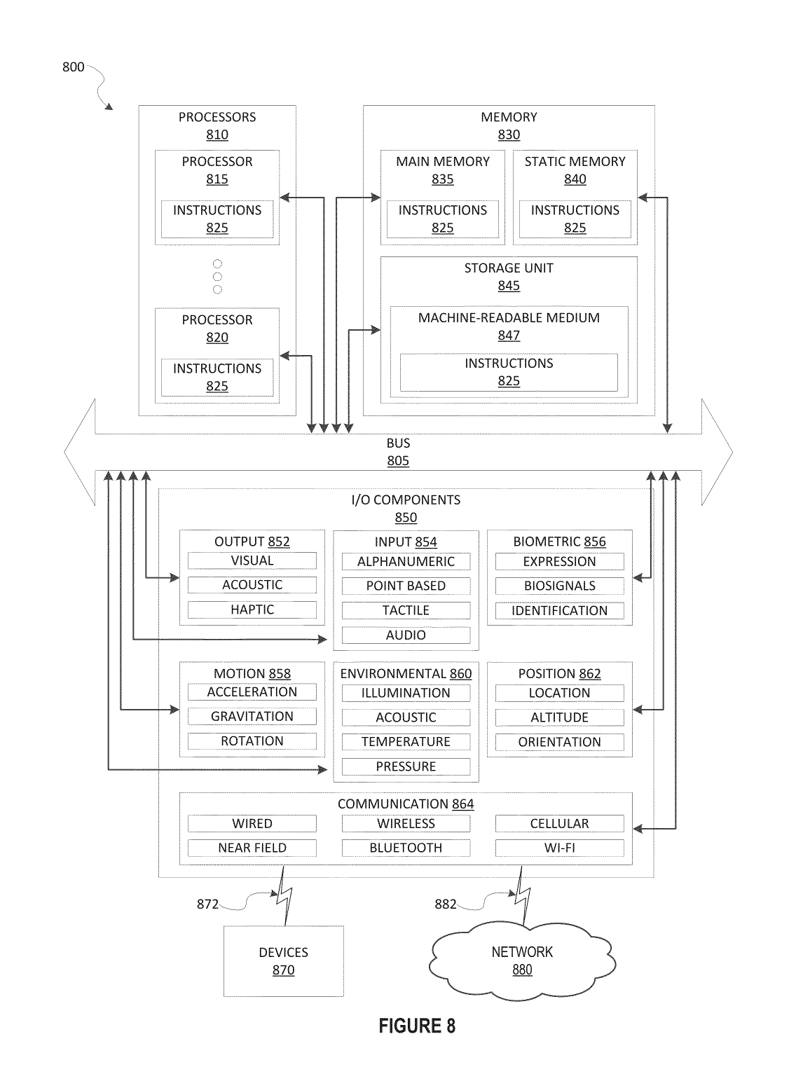

FIG. 7 is a block diagram illustrating an architecture of software 700, which may be installed on any one or more of the devices of FIG. 1 (e.g., client device(s) 110). FIG. 7 is merely a non-limiting example of a software architecture and it will be appreciated that many other architectures may be implemented to facilitate the functionality described herein. The software 700 may be executing on hardware such as machine 800 of FIG. 8 that includes processors 810, memory 830, and I/O components 850. In the example architecture of FIG. 7, the software 700 may be conceptualized as a stack of layers where each layer may provide particular functionality. For example, the software 700 may include layers such as an operating system 702, libraries 704, frameworks 706, and applications 708. Operationally, the applications 708 may invoke API calls 710 through the software stack and receive messages 712 in response to the API calls 710.

The operating system 702 may manage hardware resources and provide common services. The operating system 702 may include, for example, a kernel 720, services 722, and drivers 724. The kernel 720 may act as an abstraction layer between the hardware and the other software layers. For example, the kernel 720 may be responsible for memory management, processor management (e.g., scheduling), component management, networking, security settings, and so on. The services 722 may provide other common services for the other software layers. The drivers 724 may be responsible for controlling and/or interfacing with the underlying hardware. For instance, the drivers 724 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 704 may provide a low-level common infrastructure that may be utilized by the applications 708. The libraries 704 may include system libraries 730 (e.g., C standard library) that may provide functions such as memory allocation functions, string manipulation functions, mathematic functions, and the like. In addition, the libraries 704 may include API libraries 732 such as media libraries (e.g., libraries to support presentation and manipulation of various media formats such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 704 may also include a wide variety of other libraries 734 to provide many other APIs to the applications 708.

The frameworks 706 may provide a high-level common infrastructure that may be utilized by the applications 708. For example, the frameworks 706 may provide various graphical user interface (GUI) functions, high-level resource management, high-level location services, and so forth. The frameworks 706 may provide a broad spectrum of other APIs that may be utilized by the applications 708, some of which may be specific to a particular operating system or platform.

The applications 708 include a home application 750, a contacts application 752, a browser application 754, a book reader application 756, a location application 758, a media application 760, a messaging application 762, a game application 764, and a broad assortment of other applications such as third party application 766. In a specific example, the third party application 766 (e.g., an application developed using the Android™ or iOS™ software development kit (SDK) by an entity other than the vendor of the particular platform) may be mobile software running on a mobile operating system such as iOS™, Android™ Windows® Phone, or other mobile operating systems. In this example, the third party application 766 may invoke the API calls 710 provided by the mobile operating system 702 to facilitate functionality described herein.

### Example Machine Architecture and Machine-Readable Medium

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 825 (e.g., software, a program, an application, an applet, an app, or other executable code) for causing the machine 800 to perform any one or more of the methodologies discussed herein may be executed. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but be not limited to, a server computer, a client computer, a (PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 825, sequentially or otherwise, that specify actions to be taken by machine 800. Further, while only a single machine 800 is illustrated, the term “machine” shall also be taken to include a collection of machines 800 that individually or jointly execute the instructions 825 to perform any one or more of the methodologies discussed herein.

The machine 800 may include processors 810, memory 830, and I/O components 850, which may be configured to communicate with each other via a bus 805. In an example embodiment, the processors 810 (e.g., a CPU, a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 815 and processor 820, which may execute instructions 825. The term “processor” is intended to include multi-core processor that may comprise two or more independent processors (also referred to as “cores”) that may execute instructions contemporaneously. Although FIG. 8 shows multiple processors, the machine 800 may include a single processor with a single core, a single processor with multiple cores (e.g., a multi-core process), multiple processors with a single core, multiple processors with multiples cores, or any combination thereof.

The memory 830 may include a main memory 835, a static memory 840, and a storage unit 845 accessible to the processors 810 via the bus 805. The storage unit 845 may include a machine-readable medium 847 on which are stored the instructions 825 embodying any one or more of the methodologies or functions described herein. The instructions 825 may also reside, completely or at least partially, within the main memory 835, within the static memory 840, within at least one of the processors 810 (e.g., within the processor's cache memory), or any suitable combination thereof, during execution thereof by the machine 800. Accordingly, the main memory 835, static memory 840, and the processors 810 may be considered as machine-readable media 847.

As used herein, the term “memory” refers to a machine-readable medium 847 able to store data temporarily or permanently and may be taken to include, but not be limited to, random-access memory (RAM), read-only memory (ROM), buffer memory, flash memory, and cache memory. While the machine-readable medium 847 is shown in an example embodiment to be a single medium, the term “machine-readable medium” should be taken to include a single medium or multiple media (e.g., a centralized or distributed database, or associated caches and servers) able to store instructions 825. The term “machine-readable medium” shall also be taken to include any medium, or combination of multiple media, that is capable of storing instructions (e.g., instructions 825) for execution by a machine (e.g., machine 800), such that the instructions, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 850 may include a wide variety of components to receive input, provide and/or produce output, transmit information, exchange information, capture measurements, and so on. It will be appreciated that the I/O components 850 may include many other components that are not shown in FIG. 8. In various example embodiments, the I/O components 850 may include output components 852 and/or input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instrument), tactile input components (e.g., a physical button, a touch screen that provide location and force of touches or touch gestures, and/or other tactile input components), audio input components (e.g., a microphone), and the like.

In further example embodiments, the I/O components 850 may include biometric components 856, motion components 858, environmental components 860, and/or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), acoustic sensor components (e.g., one or more microphones that detect background noise), temperature sensor components (e.g., one or more thermometers that detect ambient temperature), humidity sensor components, pressure sensor components (e.g., barometer), proximity sensor components (e.g., infrared sensors that detect nearby objects), and/or other components that may provide indications, measurements, and/or signals corresponding to a surrounding physical environment. The position components 862 may include location sensor components (e.g., a Global Position System (GPS) receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 and/or devices 870 via coupling 882 and coupling 872, respectively. For example, the communication components 864 may include a network interface component or other suitable device to interface with the network 880. In further examples, communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine and/or any of a wide variety of peripheral devices (e.g., a peripheral device couple via a USB).

Moreover, the communication components 864 may detect identifiers and/or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar codes, multi-dimensional bar codes such as a Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In additional, a variety of information may be derived via the communication components 864 such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 880 may be an ad hoc network, an intranet, an extranet, a virtual private network (VPN), a LAN, a wireless LAN (WLAN), a WAN, a wireless WAN (WWAN), a MAN, the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network and the coupling 882 may be a Code Division Multiple Access (CDMA) connection, a Global System for Mobile communications (GSM) connection, or other type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 825 may be transmitted and/or received over the network 880 using a transmission medium via a network interface device (e.g., a network interface component included in the communication components 864) and utilizing any one of a number of well-known transfer protocols (e.g., HyperText Transfer Protocol (HTTP)). Similarly, the instructions 825 may be transmitted and/or received using a transmission medium via the coupling 872 (e.g., a peer-to-peer coupling) to devices 870. The term “transmission medium” shall be taken to include any intangible medium that is capable of storing, encoding, or carrying instructions 825 for execution by the machine 800, and includes digital or analog communications signals or other intangible medium to facilitate communication of such software.

Furthermore, the machine-readable medium 847 is non-transitory (in other words, not having any transitory signals) in that it does not embody a propagating signal. However, labeling the machine-readable medium 847 as “non-transitory” should not be construed to mean that the medium is incapable of movement; the medium should be considered as being transportable from one physical location to another. Additionally, since the machine-readable medium 847 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for purpose of explanation, has been described with reference to specific implementations. However, the illustrative discussions above are not intended to be exhaustive or to limit the possible implementations to the precise forms disclosed. Many modifications and variations are possible in view of the above teachings. The implementations were chosen and described in order to best explain the principles involved and their practical applications, to thereby enable others skilled in the art to best utilize the various implementations with various modifications as are suited to the particular use contemplated.

It will also be understood that, although the terms first, second, and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present implementations. The first contact and the second contact are both contacts, but they are not the same contact.

The terminology used in the description of the implementations herein is for the purpose of describing particular implementations only and is not intended to be limiting. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if (a stated condition or event) is detected” may be construed to mean “upon determining” or “in response to determining” or “upon detecting (the stated condition or event)” or “in response to detecting (the stated condition or event),” depending on the context.

1. A method comprising:
storing admittance data for a plurality education institutions;
receiving a request for a prediction concerning whether a first member of a social networking service will be admitted to a first education institution in the plurality of education institutions;
comparing qualification data associated with the first member to admittance data stored in memory of the social networking server;
generating an admittance prediction based on the comparison of the qualification data associated with the first member with historic admittance data; and
transmitting the admittance prediction to the client system for display.

2. The method of claim 1, further comprising:
calculating an education institution rating for the first education institution; and
determining one or more education institutions with education institution ratings comparable to the first education institution.

3. The method of claim 2, further comprising:
for a respective education institution in the determined one or more education institutions:
generating an admittance prediction for the first member based on the qualification data associated with the first member and the historic admittance data associated with the respective education institution.

4. The method of claim 3, further comprising:
determining whether, based on the generated admittance prediction, the first member is likely to be admitted to the respective education institution; and
in accordance with a determination that the first member is likely to be admitted to the respective education institution, transmitting an education institution recommendation to the first member.

5. The method of claim 1, wherein comparing qualification data for the first member to historic admittance data:
determining one or more qualification data categories;
for a respective category in the one or more qualification data categories:
determining an average acceptance category score for the respective category; and
determining a minimum acceptance category score.

6. The method of claim 5, wherein generating an admittance prediction based on the comparison with historic admittance data further comprises:
determining a first category score for the first member in the respective category;
determining whether the first category is above the minimum acceptance score;
in accordance with a determination that the first category score is not above the minimum acceptance score, generating an admittance prediction that represents a low probability of the first member being accepted into the education institution.

7. The method of claim 5, wherein the admittance prediction is represented by a percentage representing the likelihood that the member will be accepted into the respective education institution.

8. The method of claim 5, wherein generating an admittance prediction based on the comparison with historic admittance data further comprises:
determining a category score for each category in the one or more categories for the first member based on stored qualification data associated with the first member;
for each category, determining whether the category score for the first member exceeds the average acceptance category score based on historic acceptance data; and
generating the admittance prediction based on the number of categories for which the first member's category score exceeds the average acceptance category score.

9. The method of claim 1, wherein historic admittance data for a respective school includes data that identifies a plurality of potential students who applied and were accepted and a plurality of students that applied to the respective school and were rejected.

10. The method of claim 8, wherein the historic admittance data includes one or more potential students who were accepted by the respective education institution but did not attend the educational institution.

11. The method of claim 8, wherein historic admittance data includes, for each respective potential student, qualification data associated with the respective potential student.

12. The method of claim 1, wherein historic admittance data for a respective education institution is received from the respective education institution directly.

13. A system comprising:
one or more processors;
memory; and
one or more programs stored in the memory, the one or more programs comprising instructions for:
storing admittance data for a plurality education institutions;
receiving a request for a prediction concerning whether a first member of a social networking service will be admitted to a first education institution in the plurality of education institutions;
comparing qualification data associated with the first member to admittance data stored in memory of the social networking server;
generating an admittance prediction based on the comparison of the qualification data associated with the first member with historic admittance data; and
transmitting the admittance prediction to the client system for display.

14. The system of claim 12, further comprising instructions for:
calculating an education institution rating for the first education institution; and
determining one or more education institutions with education institution ratings comparable to the first education institution.

15. The system of claim 13, further comprising instructions for:
for a respective education institution in the determined one or more education institutions:
generating an admittance prediction for the first member based on the qualification data associated with the first member and the historic admittance data associated with the respective education institution.

16. The system of claim 14, further comprising instructions for:
determining whether, based on the generated admittance prediction, the first member is likely to be admitted to the respective education institution; and
in accordance with a determination that the first member is likely to be admitted to the respective education institution, transmitting an education institution recommendation to the first member.

17. A non-transitory computer readable storage medium storing one or more programs for execution by one or more processors, the one or more programs comprising instructions for:
storing admittance data for a plurality education institutions;
receiving a request for a prediction concerning whether a first member of a social networking service will be admitted to a first education institution in the plurality of education institutions;
comparing qualification data associated with the first member to admittance data stored in memory of the social networking server;
generating an admittance prediction based on the comparison of the qualification data associated with the first member with historic admittance data; and
transmitting the admittance prediction to the client system for display.

18. The non-transitory computer readable storage medium of claim 16, further comprising instructions for:
calculating an education institution rating for the first education institution; and
determining one or more education institutions with education institution ratings comparable to the first education institution.

19. The non-transitory computer readable storage medium of claim 17, further comprising instructions for:
for a respective education institution in the determined one or more education institutions:
generating an admittance prediction for the first member based on the qualification data associated with the first member and the historic admittance data associated with the respective education institution.

20. The non-transitory computer readable storage medium of claim 18 further comprising instructions for:
determining whether, based on the generated admittance prediction, the first member is likely to be admitted to the respective education institution; and
in accordance with a determination that the first member is likely to be admitted to the respective education institution, transmitting an education institution recommendation to the first member.

20. (canceled)
